(19) United States
(12) Patent Application Publication
(10) Pub. No.: US 2025/0318502 A1
(43) Pub. Date: Oct. 16, 2025

(54) Pet Water Dispenser

(71) Applicant: Dongguan Zhiyihong Hardware & Plastic Co., Ltd., Dongguan City (CN)

(72) Inventor: Zhiqi Xue, Dongguan City (CN)

(21) Appl. No.: 18/764,328

(22) Filed: Jul. 4, 2024

(30) Foreign Application Priority Data
Apr. 12, 2024 (CN) 202420758564.0

(51) Int. Cl. A01K 7/02

(52) U.S. Cl. CPC A01K 7/025

(57) ABSTRACT

A pet water dispenser comprises a shell and a water pump, wherein the shell comprises a water tank and a top cover, and the top cover covers the water tank. By implementing the technical solution, the pet water dispenser is simple in structure, low in cost and easy to produce and use, and can work together with other bowls to form a smart pet water dispenser; and the pet water dispenser can be easily cleaned by pulling a pump cartridge out of a pump housing.

### CROSS REFERENCE TO RELATED APPLICATION

This application claims priority benefit of Chinese patent Application No. 202420758564.0, filed on Apr. 12, 2024, and the entire contents of which are incorporated herein by reference.

### BACKGROUND OF THE INVENTION

### 1. Technical Field

The invention relates to the technical field of pet supplies, in particular to a pet water dispenser.

### 2. Description of Related Art

At present, existing pet water dispensers mainly adopt two types of motors: an independent brushless pump motor and an independent membrane pump motor. The brushless pump motor and membrane pump motor are both independent products, high in cost, not specially designed and difficult to clean. When the brushless pump motor or the membrane pump motor is applied to a pet water dispenser, the structure of the motor needs to be extended to realize the function of existing pump motors. In addition, because the structure of existing motors is not specifically designed and needs to be extended, existing motors consume more energy.

### BRIEF SUMMARY OF THE INVENTION

The invention provides a pet water dispenser to solve the problems of existing pet water dispensers.

A pet water dispenser comprises a shell and a water pump 3, wherein the shell comprises a water tank 1 and a top cover 2, and the top cover 2 covers the water tank 1; the water pump 3 comprises a pump cartridge 31 and a pump housing 32, the pump housing 32 extends from a lower portion of the water tank 1 into/onto the top cover 2, and a water outlet 321 is formed in the pump housing 32 and connected to a surface of the top cover 2; the pump cartridge 31 comprises a pump hood 311, a pump motor 312 and a pump blade 313, the pump motor 312 is arranged in the pump hood 311, the pump blade 313 is arranged at a bottom of the pump hood 311, and the pump motor 312 is in transmission connection with the pump blade 313; and the pump cartridge 31 is arranged in the pump housing 32, and a water passage 4 is formed between the pump cartridge 31 and the pump housing 32 and connects the water tank 1 and the water outlet 321.

Preferably, the pump cartridge 31 is movably arranged in the pump housing 32, and the pump housing 32 is movably connected to the shell.

Preferably, the pump motor 312 is arranged on a lower portion of the pump cartridge 31.

Preferably, the pump housing 32 comprises an inlet water filter screen 322, and the inlet water filter screen 322 is arranged at a bottom of the pump housing 32 and located below the pump blade 313.

Preferably, the pump motor 312 is in transmission connection with the pump blade 313 by means of a pump motor shaft 314.

Preferably, the water pump 3 comprises a power supply 3 and a control system, the power supply 7 is connected to the control system, the control system comprises a control mainboard 5 and an operation panel 6, the operation panel 6 is connected to the control mainboard 5, and the control mainboard 5 is connected to the pump motor 312.

By implementing the above technical solution, the invention fulfills the following technical effects: the pet water dispenser is simple in structure, low in cost and easy to produce and use, and can work together with other bowls to form a smart pet water dispenser; and the pet water dispenser can be easily cleaned by pulling the pump cartridge out of the pump housing.

### BRIEF DESCRIPTION OF THE SEVERAL VIEWS OF THE DRAWINGS

FIG. 1 is a perspective view of a pet water disperser according to the invention;

FIG. 2 is an exploded view of the pet water disperser according to the invention;

FIG. 3 is a front view of the pet water disperser according to the invention;

FIG. 4 is a sectional view of FIG. 3 of the pet water disperser according to the invention;

FIG. 5 is a partial enlarged view of FIG. 4 of the pet water disperser according to the invention;

FIG. 6 is a left view of the pet water disperser according to the invention;

FIG. 7 is a sectional view of FIG. 6 of the pet water disperser according to the invention.

### DETAILED DESCRIPTION OF THE INVENTION

To gain a better understanding of the technical solution of the invention, embodiments provided by the invention are described in detail below in conjunction with accompanying drawings.

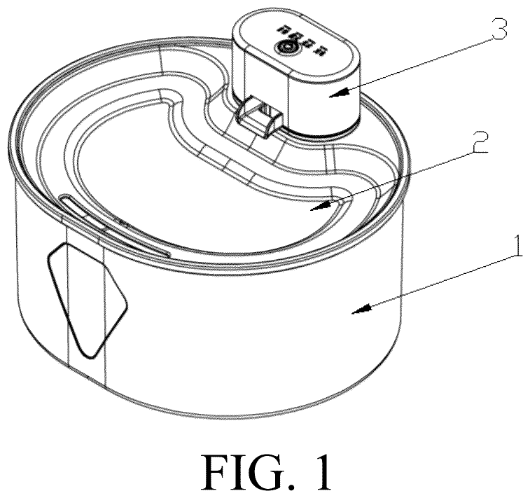

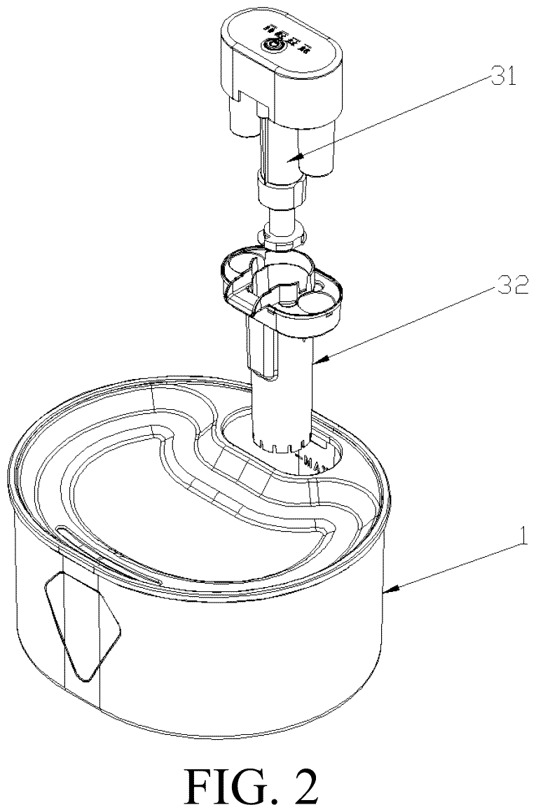

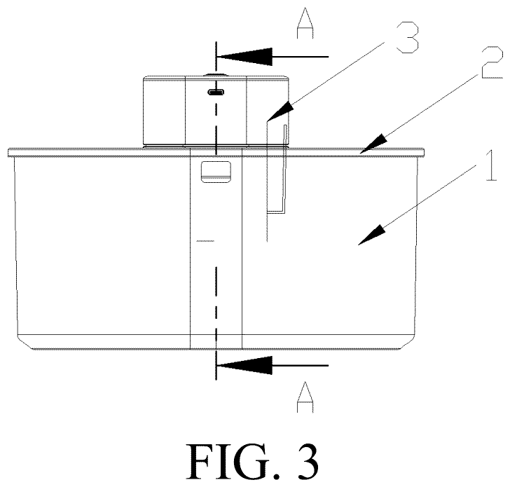

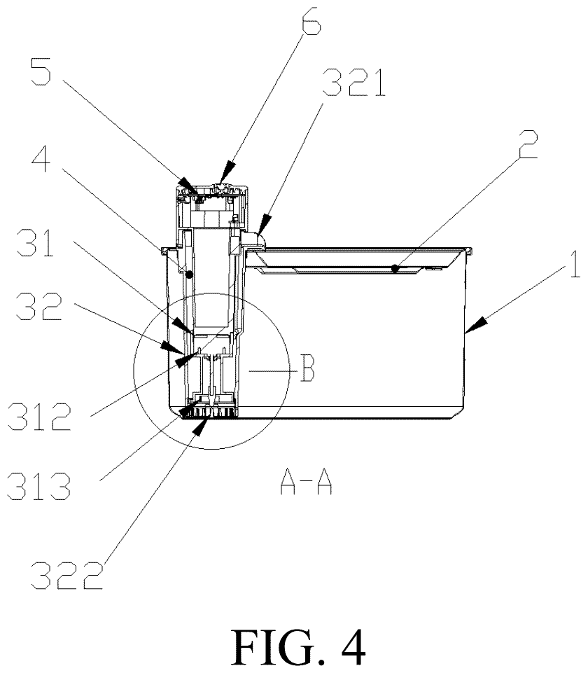

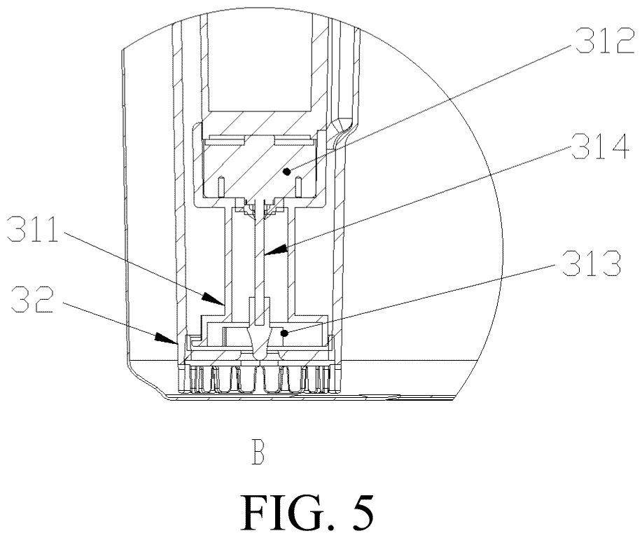

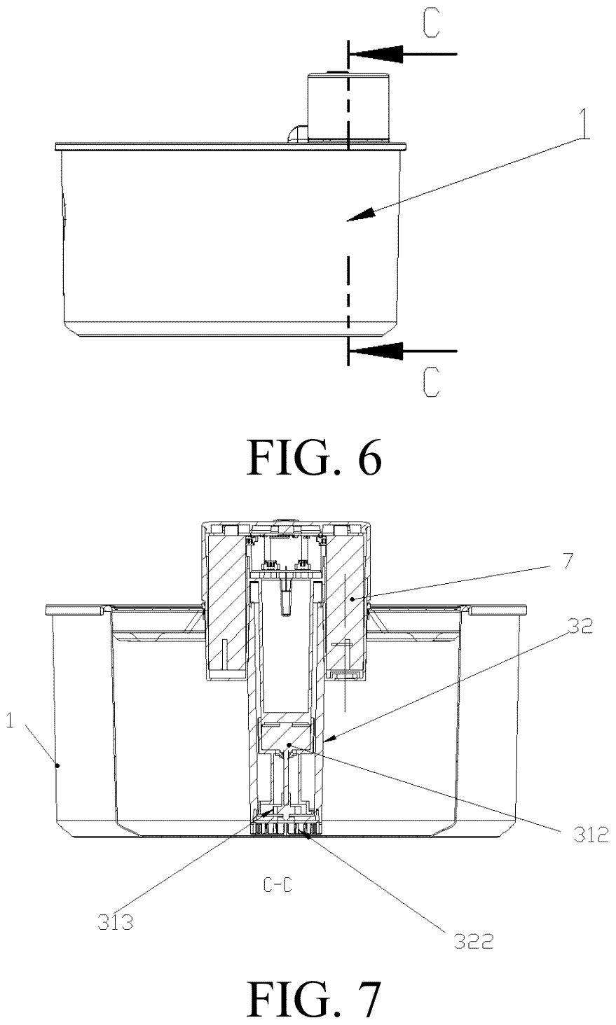

As shown in FIGS. 1-7, this embodiment provides a pet water dispenser, comprising a shell and a water pump 3, wherein the shell comprises a water tank 1 and a top cover 2, and the top cover 2 covers the water tank 1; the water pump 3 comprises a pump cartridge 31 and a pump housing 32, the pump housing 32 extends from a lower portion of the water tank 1 into/onto the top cover 2, and a water outlet 321 is formed in the pump housing 32 and connected to the surface of the top cover 2; the pump cartridge 31 comprises a pump hood 311, a pump motor 312 and a pump blade 313, the pump motor 312 is arranged in the pump hood 311, the pump blade 313 is arranged at the bottom of the pump hood 311, and the pump motor 312 is in transmission connection with the pump blade 313; and the pump cartridge 31 is arranged in the pump housing 32, and a water passage 4 is formed between the pump cartridge 31 and the pump housing 32 and connects the water tank 1 and the water outlet 321.

In this embodiment, the pump motor 312 in the pump cartridge 31 drives the pump blade 313 to rotate to drive water at the bottom of the water tank 1 to sequentially flow through the water passage 4 and the water outlet 321 to reach the top cover 2 to be fed to pets, and the pet water dispenser is directly driven by one motor, thus solving the problem of high cost and short service life of existing pet water dispensers caused by the use of a diaphragm pump motor; the water pump 3 is formed by the pump housing 32 and the pump cartridge 31 and can placed in a bowl to work after being assembled, such that the pet water dispenser is simple in structure, low in cost and easy to produce and assemble, and can work together with other bowls to form a smart pet water dispenser; the pump motor 312 is arranged in the pump cartridge 31, the pump cartridge 31 is arranged in the pump housing 32, the pump housing 32 extends from the bottom of the water tank 1 into/onto the top cover 2, such that the pump motor 312 can sink into the water tank, thus avoiding noise to reduce disturbance when pets drink water, raising the willingness to drink of the pets, and improving the use effect.

In Embodiment 2, the pump cartridge 31 is movably arranged in the pump housing 32, and the pump housing 32 is movably connected to the shell. In this way, the pet water dispenser can be easily cleaned by pulling the pump cartridge out of the pump housing, and is convenient to use.

Based on the above embodiments, further, the pump motor 312 is arranged on a lower portion of the pump cartridge 31. In this way, noise is further avoided to reduce disturbance when pets drink water, the willingness of the pets to drink is raised, and the use effect is improved.

Based on the above embodiments, further, the pump housing 32 comprises an inlet water filter screen 322, and the inlet water filter screen 322 is arranged at the bottom of the pump housing 32 and located below the pump blade 313. The inlet water filter screen 322 is used for filtering water entering the water passage 4 to improve the quality of the water so as to improve the use effect.

Based on the above embodiments, further, the pump motor 312 is in transmission connection with the pump blade 313 by means of a pump motor shaft 314. In this way, the motor is not directly connected to the pump blade 313 and is sealed, and water is prevented from entering the pump motor 312, thus avoiding damage to the pet water dispenser and prolonging the service life of the pet water dispenser.

Based on the above embodiments, further, the water pump 3 comprises a power supply 7 and a control system, the power supply 7 is connected to the control system, the control system comprises a control mainboard 5 and an operation panel 6, the operation panel 6 is connected to the control mainboard 5, and the control mainboard 5 is connected to the pump motor 312. In this way, the pet water dispenser can be controlled easily to improve usage experience.

The pet water dispenser provided by the embodiments of the invention is introduced in detail above. Those ordinarily skilled in the art can make some variations to the specific implementations and application range of the invention according to the concept of the invention. Therefore, the contents in the specification should not be construed as limitations of the invention.

1. A pet water dispenser, comprising a shell and a water pump (3), wherein the shell comprises a water tank (1) and a top cover (2), and the top cover (2) covers the water tank (1);
the water pump (3) comprises a pump cartridge (31) and a pump housing (32), the pump housing (32) extends from a lower portion of the water tank (1) into/onto the top cover (2), and a water outlet (321) is formed in the pump housing (32) and communicated to a surface of the top cover (2);
the pump cartridge (31) comprises a pump hood (311), a pump motor (312) and a pump blade (313), the pump motor (312) is arranged in the pump hood (311), the pump blade (313) is arranged at a bottom of the pump hood (311), and the pump motor (312) is in transmission connection with the pump blade (313);
the pump cartridge (31) is arranged in the pump housing (32), and a water passage (4) is formed between the pump cartridge (31) and the pump housing (32) and connects the water tank (1) and the water outlet (321);
the water outlet is provided above the surface of the top cover.

2. The pet water dispenser according to claim 1, wherein the pump cartridge (31) is movably arranged in the pump housing (32), and the pump housing (32) is movably connected to the shell.

3. The pet water dispenser according to claim 1, wherein the pump motor (312) is arranged on a lower portion of the pump cartridge (31).

4. The pet water dispenser according to claim 1, wherein the pump housing (32) comprises an inlet water filter screen (322), and the inlet water filter screen (322) is arranged at a bottom of the pump housing (32) and located below the pump blade (313).

5. The pet water dispenser according to claim 1, wherein the pump motor (312) is in transmission connection with the pump blade (313) through a pump motor shaft (314).

6. The pet water dispenser according to claim 1, wherein the water pump (3) comprises a power supply (7) and a control system, the power supply (7) is connected to the control system, the control system comprises a control mainboard (5) and an operation panel (6), the operation panel (6) is connected to the control mainboard (5), and the control mainboard (5) is connected to the pump motor (312).

7. The pet water dispenser according to claim 1, wherein the surface of the top cover is provided with a bowl configured to hold water discharged from the water outlet.

8. The pet water dispenser according to claim 1, wherein the pump housing extends from a bottom of the water tank into/onto the top cover.
